(19) United States
(12) Patent Application Publication
(10) Pub. No.: US 2008/0232608 A1
(43) Pub. Date: Sep. 25, 2008

(54) Audio/Video System

(75) Inventor: Paul Ullmann, Vienna (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,411

(22) PCT Filed: Jan. 26, 2005
(86) PCT No.: PCT/IB2005/050312

§ 371 Date: Jul. 25, 2006

(30) Foreign Application Priority Data
Jan. 29, 2004 (EP) 04100323.7

(51) Int. Cl. H04B 3/00

(52) U.S. Cl. 381/77

(57) ABSTRACT

In an audio/video system having an audio reproduction device (CU) for reproduction of audio signals via at least one loudspeaker unit (LSB1-LSB5) and having an ultrasonic signal-generating device (6) for generating ultrasonic signals (UT1-UT3; UT4), wherein the ultrasonic signal-generating device (6) is designed to emit the ultrasonic signals to at least one loudspeaker unit (LSB1, LSB3), which loudspeaker unit is designed to emit the ultrasonic signals, and having an ultrasonic signal-receiving device (5) for receiving ultrasonic signals (UR1-UR3; UR4) and having an ultrasonic signal-processing unit (7) for processing ultrasonic signals received by the ultrasonic signal-receiving means (5), the ultrasonic signal-processing unit (7) is designed automatically to detect the presence of at least one person (1) from changes in the received ultrasonic signals (UR1-UR3; UR4) and to emit a detection signal (DS).

### FIELD OF THE INVENTION

The field of invention relates to an audio/video system having an audio reproduction device for reproduction of audio signals via at least one loudspeaker unit and having ultrasonic signal-generating means for generating ultrasonic signals and having ultrasonic signal-receiving means for receiving ultrasonic signals, and having ultrasonic signal-processing means for processing the ultrasonic signals received by the ultrasonic signal-receiving means.

### BACKGROUND OF THE INVENTION

The document GB 2 203 315 A discloses a multi-channel audio system, which multi-channel audio system comprises a multi-channel amplifier device for amplifying audio signals and loudspeaker enclosures for acoustic reproduction of the amplified audio signals. Furthermore, this known multi-channel audio system comprises measuring devices for measuring the instantaneous distances between the individual loudspeaker enclosures and a listener moving relative to the loudspeaker enclosures. In the case of the known multi-channel audio system, control means are additionally provided. On the basis of the distances determined, these control means control a balance regulator of the amplifier device to balance the reproduction volume of the individual audio channels, resulting in a balanced volume relationship between the individual audio channels for the listener. The distance-measuring devices work on the basis of ultrasonic signals or infrared signals. In one embodiment of the distance-measuring device based on ultrasonic signals, an ultrasonic transmitter is provided, which emits an ultrasonic pulse that is reflected at the listener and hence returned to the measuring device, where this reflected signal is received by an ultrasonic receiver and the distance between the distance-measuring device and the object at which the ultrasonic signal was reflected is calculated from the transit time from sending of the signal to reception of the reflected signal. Both the ultrasonic transmitter and the ultrasonic receiver of the distance-measuring device are arranged at the loudspeaker enclosures or close to the loudspeaker enclosures.

In the case of the known multi-channel audio system, it has, however, proved a disadvantage that the distance-measuring device is able to provide satisfactory results on the basis of ultrasonic signals only under highly idealized conditions, but such idealized conditions hardly ever occur in practice. Thus, for example, it is a condition that the listening room in which the multi-channel audio system and the listener are to be found is defined by non-reflecting walls or walls that reflect very little, so that multiple reflections of the emitted ultrasonic signal, which would falsify the distance measurement results, do not occur. An even more serious drawback is the fact that the measuring device of the known multi-channel audio system is unable per se to distinguish between reflections of the ultrasonic signal coming from the listener and those reflections coming from items of furniture or the like. Early reflections that come from objects in front of the listener can therefore falsify the measurement result. To remedy this serious disadvantage, in the case of the known multi-channel audio system it is necessary for the listener initially to identify himself to the known multi-channel audio system as the “target” for the ultrasonic signals—albeit in a manner not specifically defined—that is to say, the listener has to disclose his instantaneous position and the distances to the individual loudspeaker enclosures through at least one interaction with the known multi-channel audio system. As soon as the known multi-channel audio system has “captured” the position of the listener once, further detection of the position of the listener is effected in such a way that when echoes are identified where previously there was no echo, a plausibility check is carried out, which plausibility check establishes whether the new echo is located near enough to the “captured” position of the listener to say that the listener could actually have moved to the newly detected position, and whether no echo is receivable at the listener's original position. This plausibility check is bound to fail if there are several persons (or even pets) moving around in the listening room. In addition, the known document has no specific proposal at all as to how this proposed plausibility check could be converted into practice and how the listener is to log on to the multi channel audio system so that this is able to “capture” his location. One must also proceed on the assumption that consumers are not willing to go through a process of logging on to the known multi-channel audio system every time they switch on the multi-channel audio system or enter the listening room.

### OBJECT AND SUMMARY OF THE INVENTION

It is an object of the invention to produce an audio/video system of the kind specified in the first paragraph, which avoids the above-mentioned disadvantages.

To achieve the above-mentioned object, in an audio/video system in accordance with the invention inventive features are provided, so that an audio/video system in accordance with the invention is characterizable in the manner specified in the following, namely:

Audio/visual system having an audio reproduction device for reproduction of audio signals via at least one loudspeaker unit and having ultrasonic signal-generating means for generating ultrasonic signals, wherein the ultrasonic signal-generating means are designed to emit the ultrasonic signals to at least one of the loudspeaker units, which loudspeaker unit is designed to emit the ultrasonic signals, and having ultrasonic signal-receiving means for receiving ultrasonic signals, and having ultrasonic signal-processing means for processing ultrasonic signals received by the ultrasonic signal-receiving means, wherein the ultrasonic. signal-processing means are constructed automatically to detect the presence of at least one person from changes in the received ultrasonic signals and to emit a detection signal.

The features according to the invention enable persons present in the room to be detected automatically, without them having to enter into prior interactive contact with the audio/video system. This provides considerably improved operating convenience compared with the known multi-channel audio system and the possibility of spurious detections on the basis of false or lacking user interaction is eliminated. Furthermore, for implementation of the invention hardly any additional outlay on hardware is required in the audio/video system compared with known systems, since the features of the invention can be implemented on the basis of the components that are present anyway in modern audio/video systems.

It should additionally be mentioned that the invention is not restricted to combined audio/video systems, especially not to multi-channel audio/video systems, but includes all types of pure audio systems. Such audio systems comprise stereo systems, both integrated systems and component systems, also 5.1 channel AV systems, 7.1 channel systems, all types of DVD recorders, DVD players, receivers, SACD multi-channel systems, DVDA multi-channel systems and so-called “bedroom systems”, the latter being audiovisual or pure audio systems which are tailored specifically to human interactivity requirements when going to sleep and when rising or following one's early morning ritual.

The advantage obtained in accordance with the measures of claim 2 is that the detection of persons is effected in the time domain of the ultrasonic signals and hence the demands on the processing speed of the ultrasonic signal-processing means are not overly great. It is advantageous therein if the ultrasonic signal-processing means are in the form of digital signal processors, since signal processors contain all functions necessary for evaluating echo patterns in the time domain.

The advantage obtained in accordance with the measures of claims 3 and 4 is that the subdivision into individual time slots enables the accuracy of detecting persons present to be increased. In addition, the time slots in which changes are ascertained simultaneously offer a measure for the distance covered by the ultrasonic signal from its emission from the loudspeaker unit through reflection at an object to arrival at the ultrasonic signal-receiving means.

The advantage achieved in accordance with the measures of claims 5, 6 and 7 is an extremely fail-safe detection in the frequency domain of the received reflected ultrasonic signals. The reliability and accuracy of detection can be further enhanced by including pre-determined minimum levels of signals in frequency bands. By exploiting the Doppler effect, it is furthermore possible to determine the direction of movement and speed of movement of the object at which the ultrasonic signals are being reflected.

The advantage obtained in accordance with the measures of claim 8 is that the ultrasonic signal-receiving means are incorporated as an inexpensive and reliable component.

The advantage obtained in accordance with the measures of claim 9 is that existing loudspeaker enclosures present anyway in many audio/video systems can be used and therefore no additional hardware is required for emitting ultrasonic signals.

The advantages obtained in accordance with the measures of claims 10 and 11 are that the need for a user to interact with an audio/video system is reduced and that convenience of operation for the user is enhanced, since any actions that he would carry out in specific situations and at specific times are automatically anticipated and implemented by the system.

The advantage obtained in accordance with the measures of claims 12 and 13 is that the audio/video system also fulfils the function of an alarm system.

The advantage obtained in accordance with the measures of claims 14 to 18 is that the reproduction parameters of the individual audio channels are re-adjusted according to the position of the user or of several persons occupying the room. These reproduction parameters comprise an advantageous setting of the volumes (balance) of the individual audio channels and/or an advantageous setting of the propagation delays (delay) of the individual audio channels and/or an advantageous setting of the frequency characteristic of the individual audio channels and/or an advantageous setting of the mechanical position of the individual loudspeaker units.

The advantage obtained in accordance with the measures of claim 19 is that apart from detection of the mere presence of at least one person in the room, his position in the room is determined as well, and this information can be used to adjust the above-mentioned reproduction parameters.

These and other aspects of the invention are apparent from and will be elucidated, by way of non-limitative example, with reference to the embodiments described hereinafter.

### BRIEF DESCRIPTION OF THE DRAWINGS

In the drawings:

FIG. 1 shows schematically an audio/video system according to the invention.

FIG. 2 shows ultrasonic echo patterns to be analyzed by the ultrasonic signal-processing means in the audio/video system according to the invention.

FIG. 3 shows schematically a further embodiment of an audio/video system according to the invention.

### DESCRIPTION OF EMBODIMENTS

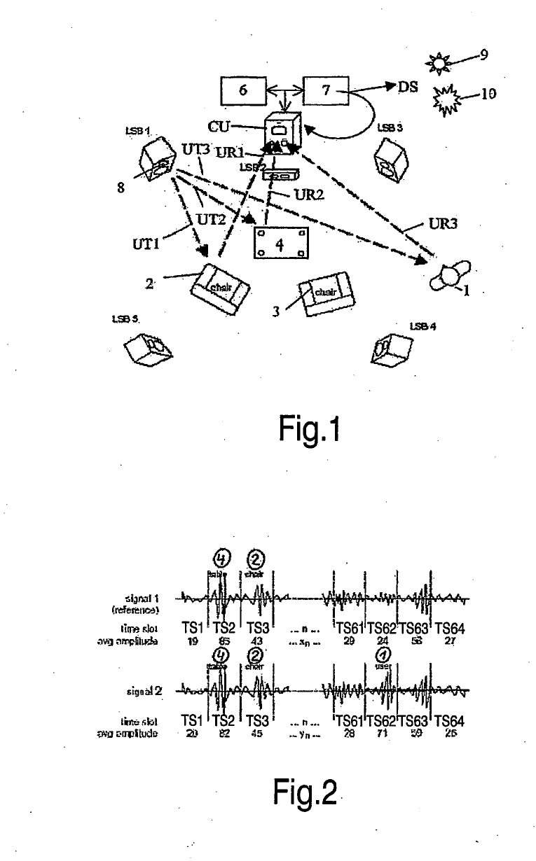

FIG. 1 shows schematically an audio/video system according to the invention, which is in the form of a surround audio/video system consistent with the 5.1 multi-channel standard. 5.1 multi-channel standard means that the following audio channels are present: front left, front center, front right, rear left, rear right plus a subwoofer channel for transmission of extremely low notes that the human ear can hear but cannot localize, so that in this surround system they have no location assigned to them. The audio/video system under consideration here comprises an audio reproduction device CU, which is also referred to as “central unit” among experts and which is designed to reproduce audio signals of all audio channels. It should be mentioned that the audio reproduction device also contains devices for processing and displaying visual signals as well as devices for entering audio data and audio/video data that is stored on storage media, for example, DVDs or CDs, or on magnetic, magneto-optic or memory-IC based storage media etc., or is transmitted via a network. For reasons of clarity, and since they are not connected with the present invention, these devices were omitted from the illustration. It should also be mentioned that the invention is not restricted to audio/video systems, especially not to multi-channel audio/video systems, but also extends to all kinds of pure audio systems. The audio reproduction device CU processes the entered data by extracting from it the audio signals of the individual audio channels, treating them (for example by increasing or decreasing specific frequency ranges) and amplifying them. The amplified audio signals of all audio channels are relayed by means of loudspeaker cables (not illustrated) or where appropriate wirelessly to loudspeaker units, which can be in the form of individual loudspeakers or—as in the present embodiment—in the form of loudspeaker enclosures. The loudspeaker units emit the received audio signals in the form of audible sound. According to the 5.1 multi-channel standard, the following loudspeakers, which are associated with the above-mentioned audio channels, are provided: front left loudspeaker enclosure LSB1, front center loudspeaker enclosure LSB2, front right loudspeaker enclosure LSB2, loudspeaker enclosure LSB5 (rear left), loudspeaker enclosure LSB4 (rear right), plus a bass loudspeaker enclosure (subwoofer) not shown. Ordinarily, the front left and front right loudspeaker enclosures LSB1, LSB3 are the highest in quality terms of the distributed loudspeaker system, that is, the ones with the largest frequency response and the lowest distortion, since they emit the main component of music and directional hearing is likewise effected primarily by way of these loudspeakers. The front center loudspeaker enclosure LSB2 serves primarily to reproduce speech in films, so that its frequency response need not encompass the entire audible range but can be restricted to, for example, less than ten (10) kHz. The quality requirements for the rear loudspeakers LSB4, LSB5 are generally lower, since they transmit on the one hand mainly background noise from films, the level of which compared with the overall transmitted sound energy is usually low. In the illustration of FIG. 1, the set-up of the audio/video system is shown in a typical listening room, such as a living room, in which, apart from the components (CU, LSB1-LSB5) of the audio/video system, there is a user or person 1, two chairs 2, 3 and a table 4, the person 1 being referred to hereinafter as the listener.

Ultrasonic signal-generating means 6 for generating inaudible ultrasonic signals are integrated in the audio reproduction device CU, the generated ultrasonic signals being emitted via the front left loudspeaker enclosure LSB1 into the listening room. The ultrasonic signals generated can comprise, for example, a regular sequence of ultrasonic pulses. In a preferred embodiment of the invention, the ultrasonic signals are emitted via a tweeter loudspeaker 8, which is one component of the front left loudspeaker enclosure LSB1 and is constructed so that in addition to acoustic signals in the audible frequency range it is also able to emit ultrasonic signals. Where the front left loudspeaker enclosure LSB1 is of such a construction, there are no extra component costs; on the contrary, the components already present can be assigned additional functions. The requirement that the tweeter loudspeaker 8 is able to transmit a frequency range above the audible range of max: 20 kHz is already met by many commercially available loudspeaker enclosures, which are capable, for example, of sound transmission up to 40 kHz and can therefore be used for the present purposes. Alternatively, existing loudspeaker enclosures could be retrofitted with an ultrasonic tweeter loudspeaker in order to be able to transmit signals in the required ultrasonic frequency range.

The ultrasonic signals emitted from the tweeter loudspeaker 8 comprise inter alia the ultrasonic signal components UT1, UT2 and UT3. The ultrasonic signal component UT1 is reflected at the chair 2 and diverted as reflected ultrasonic signal UR1 to the audio reproduction device CU, where it is received by ultrasonic signal-receiving means 5. Similarly, the ultrasonic signal component UT2 is reflected at the table 4 and the reflected ultrasonic signal UR2 is received by the ultrasonic signal-receiving means 5. Furthermore, the ultrasonic signal component UT3 is reflected at the listener 1 and the resulting reflected ultrasonic signal UR3 is received by ultrasonic signal-receiving means 5. Since the distances from tweeter loudspeaker 8 to the individual reflecting objects chair, table and listener and onwards to the ultrasonic signal-receiving means are different in length, the individual reflected ultrasonic signal components arrive in the sequence UR2→UR1→UR3 at the ultrasonic signal-receiving means 5 and together form an ultrasonic echo pattern with changing time response and frequency response characteristics.

The ultrasonic signal-receiving means 5 are advantageously built into the audio reproduction device CU and can preferably be in the form of a capacitor microphone, which capacitor microphone is not only inexpensive but also has a satisfactory frequency response. The reflected ultrasonic signal components UR1, UR2 and UR3, or rather the ultrasonic signal echo pattern formed by them, received by the ultrasonic signal-receiving means 5 is relayed to ultrasonic signal-processing means 7, where the echo patterns are analyzed, as described in detail in the following. The processing means 7 are here advantageously integrated in the audio reproduction device CU and in an especially preferred embodiment are realized as a digital signal processor (DSP). Furthermore, it is expedient for a bandpass filter and a preamplifier to be inserted between the ultrasonic signal-receiving means 5 and the processing means 7, the preamplifier amplifying the signals filtered by the bandpass filter and received by the ultrasonic signal-receiving means 5, in order to match these signals in an optimum manner to the input sensitivity and the dynamic range of the processing means 7.

It should be mentioned that although in the embodiment of the invention illustrated in FIG. 1 the ultrasonic signals are emitted only via a front left loudspeaker enclosure LSB1, it is also possible and expedient to emit the ultrasonic signals via one or more further loudspeaker units, for example, the front right loudspeaker enclosure LSB2, for which the same requirements in respect of the frequency range apply as for the left front loudspeaker enclosure LSB1. When ultrasonic signals are emitted via more than one loudspeaker unit, it becomes less likely that certain reflected ultrasonic signal components will be shadowed by other objects situated in the listening room and therefore not reach the ultrasonic signal-receiving means.

FIG. 2 shows a time chart of the ultrasonic echo pattern at two different times (signal 1 and signal 2 respectively) received by the ultrasonic signal-receiving means 5 and relayed to the processing means 7. The respective echo pattern (signal 1, signal 2) is stored temporarily in order to be analyzed by the processing means 7, for which purpose the processing means 7 are advantageously in the form of a DSP. For example, the illustrated time characteristic of each echo pattern (signal 1 and signal 2 respectively) can comprise a period of 50 milliseconds, which corresponds to a distance of an emitted and reflected ultrasonic signal of about 16 meters. In the present embodiment, the echo pattern is subdivided into 64 time slots, which are each evaluated separately, for example, by determining the average amplitude of the signal portion of each time slot. In FIG. 2, the time characteristic of an echo pattern (signal 1) at a first instant or moment is illustrated in the first line of the diagram; also shown is the subdivision into the individual time slots, which time slots are numbered consecutively in the second line of the diagram from a first time slot TS1 to a sixty-fourth time slot TS64. The average amplitude values determined and standardized for the respective time slot are plotted in the third line of the diagram. Similarly, the time characteristic of an echo pattern (signal 2) at a second instant is plotted in the fourth line of the diagram, the numbering of the time slots of the second echo pattern are plotted in the fifth line and the average amplitude values determined and standardized for the respective time slot are plotted in the sixth line. In each echo pattern (signal 1 and signal 2), one can see in the second time slot TS2 the increased signal levels, which were caused by the ultrasonic signal components UR2 reflected at the table 4. Furthermore, in the third time slot TS3 one can see the increased signal level caused by the ultrasonic signal components UR1 reflected at the chair 2, these signal components arriving later than the ultrasonic signal components UR2 owing to the longer distance they cover. The processing means 7 evaluate the change in the echo patterns for each individual time slot in accordance with the respective average amplitude, slight differences being disregarded. In the time slots TS1 to TS61 there are no significant changes between the illustrated echo patterns (signal 1 and signal 2). But in the time slot TS62 one can observe a strong signal level in the second echo pattern (signal 2) and an increase in the average amplitude from 24 to 71 units, which are attributable to the reflected ultrasonic signal component UR3 caused by the person 1. The processing means 7 interprets this change to the effect that the person 1 has entered the listening room between the detection times of signal 1 and signal 2 or has at least come within the detection range of the system. If the person 1 now remains where he is standing, then similar signals and average amplitudes would appear in time slot TS62 for subsequent echo patterns as well. If the person 1 should move nearer to the front left loudspeaker enclosure LSB1, however, then the signals of time slot TS62 would appear in the next echo patterns in time slots with lower numbers, from which the processing means 7 can recognize not only that the person is moving but can also recognize at what relative speed he is moving. It should be mentioned that the processing means 7 can alternatively use criteria other than the average amplitude for comparing an echo pattern with previous echo patterns. The processing means 7 are constructed so that they are capable of simultaneously analyzing changes in several time slots. In point of fact, however, changes will occur only in few time slots from one detected echo pattern to the next. This fact can be used for dynamic calibration of the processing means.

The described mode of operation of the processing means is based on the signal processing in the time domain, by comparing the time characteristic of a current echo pattern with one or more preceding echo patterns. As an alternative thereto, or in combination therewith, the processing means 7 can also be constructed so that they work in the frequency domain. More precisely, the Doppler effect can be exploited to determine frequency shifts in reflected ultrasonic signals, which reflected ultrasonic signals are reflected at a moving object. The movement of this object causes the frequency shift, the proviso being that the ultrasonic signal-generating means and the ultrasonic signal-receiving means and the transmission medium (the air in the listening room) are static. The ultrasonic signal generated by the ultrasonic signal-generating means is preferably a uniform signal, for example, a sinusoidal signal of constant frequency in the ultrasonic range. The ultrasonic signal-receiving means therefore receive a mixture comprising the original ultrasonic signal and reflected signal components, and convert these ultrasonic signals into electrical signals that are relayed to the processing means 7, which are expediently in the form of a DSP; this DSP is able to execute frequency-processing algorithms, like different adjustable and parameterizable filters, fast Fourier transformations etc. The DSP is programmed so that the received original signal is suppressed and only signal components having those frequencies that lie in a reasonable frequency range above and below the original frequency are allowed through. Reasonable frequency range means that, for example, any shifts that according to the Doppler effect by calculation show a speed of the moving object of more than eight (8) m/s are to be disregarded. The presence of frequency-shifted reflected ultrasonic signal components indicates that a moving person is in the listening room, whereupon the processing means deliver a detection signal DS (see FIG. 1). In addition, the amplitude of the shifted frequencies respectively frequency bands can be evaluated and the detection signal DS can be delivered only when a threshold amplitude is exceeded. In this way, the system is unaffected by air currents, flying insects and pets.

In a further development of this embodiment of the processing means, the speed of the object projected onto an axis can be calculated from the magnitude of the frequency shift. This is especially important for those systems in which the ultrasonic signals (simultaneously or consecutively) are emitted via more than one loudspeaker enclosure, so that the direction of movement and absolute speed of the detected person can be measured and supplied to the audio reproduction device as a component of the detection signal, in order at the audio reproduction device to change, if applicable, sound settings etc.

It can be mentioned that the emitted ultrasonic signal need not necessarily be uniform. The only condition that must be satisfied is that the processing means is able to distinguish between the original signal (which typically has a high amplitude) and the frequency-shifted reflections (which typically have a low amplitude). Moreover, it can be mentioned that, to increase the accuracy of detection, it is advantageous for detection in the time domain and detection on the basis of the frequency shift to be combined with one another. Detection can be carried out continuously or periodically, or alternatively at intervals that are automatically adapted to user profiles. Furthermore, detection of persons in the listening room can be carried out irrespective of whether the audio reproduction device is emitting audio signals or is merely in standby-mode.

The above-mentioned term “user profile” shall to be understood as follows:

The audio reproduction device CU records operations that a user carries out the audio reproduction device, such as, for example, switching it on and off, sound settings (volume, level, bass), the pre-setting and selection of specific radio channels etc. This data is stored in the audio reproduction device, preferably with a time reference. Further data to be stored comprises the data determined by the ultrasonic signal-processing means, namely, when a person is in the listening room and where he/she is located (the corresponding configuration of the processing means is explained in the following). Using this data, different listening habits can be established, for example, when the person 1 sits in the chair 2 he/she sets the volume control to a high volume, that is, he/she wants to concentrate on listening to reproduced music. If, however person 1 is moving around in the listening room, he/she has usually tuned in to a specific radio station that reproduces music requiring a lower level of concentration. In that case, the person obviously allows a constant stream of music to go on in the background. All this data can be additionally combined with a time reference, such as the time of day, the days of the week etc.

The audio/video system according to the invention can be adjusted so that it correlates the data records with one another, in order to search out specific statistical correlations, as well as the degree of probability that possible predictions of user actions will apply. As soon as specific conditions obtain, for instance, the presence of the user of the audio/video system in the listening room at specific times of the day, and the audio/video system is able to relate this to a statistically significant behavior pattern from the past, the audio/video system implements this behavior pattern by effecting the settings corresponding to that behavior pattern. Of course, the user will still be able to influence the audio/video system by deleting, for example, undesired behavior patterns.

The practical advantages of the described aspect of the invention are that the situations in which a user has to interact explicitly with the audio/video system are minimized; at the same time, however, the audio/video system still remains fully adaptable to different user habits. This can be illustrated by an example: in the morning, regularly between 7:00 and 7:30, a user listens to the morning news of a specific radio station at a specific volume and sound setting. As soon as the audio/video system has detected this behavior pattern, it automatically makes the necessary adjustments to the audio/video system. If, however, the user does not enter the listening room at the customary time, for example, at the weekend or if he is ill, then the audio/video system recognizes this situation and does not perform the otherwise customary operations. The audio/video system is in some measure or quasi self-learning.

Finally, it should be mentioned that in FIG. 1 all of the data detectable by the processing means have been subsumed under the term detection signal DS represented as an arrow. Since all this data can be used both externally (as described below) and internally in the audio/video system to adapt settings or to determine the user profile, the arrow comprises both an external branch and a branch led back to the audio/video system, which symbolizes the internal processing of the detection signal DS.

According to a further aspect of the invention, detection by the processing means of persons in the listening room can also be used to extend the audio/video system according to the invention by giving it the function of an alarm system. For that purpose, the detection signal DS generated by the processing means 7 is designed to trigger an audible alarm device 9, such as, for example, a siren installed in the house, or to send an alarm message via a communications network 10, for example to a police station. Clearly, the audio/video system itself can issue an audible alarm signal via the loudspeaker enclosures LSB1 to LSB5.

For that purpose, the audio/video system has at least two modes of operation. In the first mode of operation the alarm function is not activated, whereas in the second mode of operation it is activated. If the user switches the audio/video system into the alarm operating mode, then it activates the alarm operating mode with a certain delay in order to allow the user time to leave the room. Should a person 1 enter the room after the alarm operating mode has been activated, then, likewise not until after a certain delay of, for example, 30 seconds, the processing means 7 generate the detection signal DS, which triggers the alarm. This delay is expedient, so that the proper user, should he enter the listening room, is given sufficient time to disable the alarm function. Disabling can be effected, for example by pressing a sequence of control buttons on the audio/video system or on a remote control.

It shall be understood that the proposed alarm function does not offer a comprehensive protection against break-ins, and can also be rendered inoperative by burglars relatively easily. Nevertheless, the alarm function can in most cases be employed effectively.

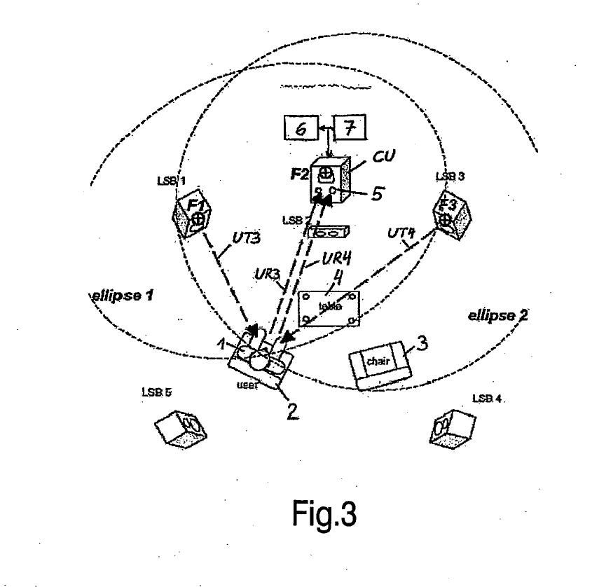

According to a third aspect of the invention, not only is a detection carried out to ascertain whether a person is staying in the room; in addition, by appropriate design of the ultrasonic signal-generating means 6 and the ultrasonic signal-receiving means 5 and the ultrasonic signal-processing means 7, the position of this person is computed as well, as is illustrated schematically in FIG. 3. FIG. 3 again shows an audio signal reproduction system according to the invention having an audio reproduction device CU and loudspeaker enclosures LSB1 to LSB5 and the ultrasonic signal-generating means 5 and the ultrasonic signal-receiving means 6 and the ultrasonic signal-processing means 7. In this respect this version of the audio/video system according to the invention is identical with the version as shown in FIG. 1, which is why a repeated explanation is omitted. As already illustrated in FIG. 1, apart from the audio signal reproduction system, the room contains a chair 2 and the person 1 and a further chair 3 and a table 4. In order to measure the position of the person 1, it is necessary for ultrasonic signals to be emitted via at least two loudspeaker enclosures and for the processing means 7 to be designed so that they eliminate from the echo patterns received by the ultrasonic signal-receiving means 5 the unchanging echoes from ultrasonic signal components reflected at static items of furniture, such as the table 4 or the chairs 2, 3. Since the parameter to be measured is the delay times that elapse from sending of an ultrasonic signal UT3 from the front left loudspeaker enclosure LSB1 to arrival at the ultrasonic signal-receiving means 5 of the ultrasonic signal component UR3 reflected at the person 1, and from sending of an ultrasonic signal UT4 from loudspeaker enclosure LSB3 to arrival at the ultrasonic signal-receiving means 5 of the ultrasonic signal component UR4 reflected at the person 1, at each measurement the position of the person 1 can be localized to lie on an ellipse, the focal points of which are the ultrasound source on the one hand and the ultrasonic signal-receiving means on the other hand. For the ultrasonic signals UT3 sent from the front left loudspeaker enclosure LSB1, the ellipse “ellipse 1” having the focal points F1, F2 can thus be defined, the position of the person 1 being localized on this ellipse. For the ultrasonic signals UT4 sent from the front right loudspeaker enclosure LSB2, the ellipse “ellipse 2” having the focal points F3, F2 can thus be defined, the position of the person 1 being localized on this ellipse. One of the two focal points of the two ellipses (the one at chair 2) is now in fact that point at which the person 1 is located; with the customary arrangement of loudspeaker enclosures and audio reproduction device CU, the second point of intersection would lie behind this arrangement and for practical reasons can consequently be excluded. To increase measuring reliability, further ultrasonic measurements can be taken by means of other loudspeaker enclosures (LSB4, LSB5) and the resulting ellipses, which overlap one another, can be evaluated by utilizing their points of intersection. In order to minimize the risk of measuring errors, the loudspeaker enclosures ought not to stand too close to one another and the person to be measured ought not to be shadowed by items of furniture and the person ought to remain within a region that is defined by the locations of the loudspeaker enclosures. With this arrangement it is also possible to measure the positions of several persons.

Once the audio/video system has determined the position of the person, it can use this position information to adjust the “sweet spot”, that is, the balance between the individual audio channels most favorable for a specific position of the listener, by changing the volume of the individual audio channels. If necessary, a time delay period of, for example, a minute, can be set, during which period the position of the listener should not alter substantially before the “sweet spot” adaptation is carried out. As an alternative thereto, for a listener moving around in the room the “sweet spot” adaptation can be continuously adapted to the instantaneous position of the listener. If there are several persons in the room, it is also possible to calculate and adjust a “sweet spot” setting that is the best possible compromise for all persons present. In that case, the “sweet spot” will in fact lie between the positions of all persons present in the room, wherein said compromise can be determined, for example, by averaging all positions of the persons present. Apart from the volume of the individual audio channels, other parameters can be set on the audio reproduction device for adaptation of the “sweet spot”, for example, different delay periods of signal transit times of the individual audio channels. Preferably, the audio/video system has several operating modes to be adjusted by the user, namely, immediate response to position changes of the persons present and time-delayed response to position changes of the persons present and changing of an automatically calculated “sweet spot” only after confirmation by a user (for example, via a remote control) and manual readjustment of the “sweet spot” by a user (for example, via a remote control) and switching off the means for ultrasonic detection and for “sweet spot” adaptation.

The important advantage of this version of the audio/video system according to the invention is that the manual adjustments to the audio/video system needed to achieve the best possible sound characteristics are reduced to a minimum. Moreover, especially when there are several persons in the room, the “sweet spot” calculated by the audio/video-system is usually better than a manual adjustment by a user.

1. An audio/video system having an audio reproduction device (CU) for reproduction of audio signals via at least one loudspeaker unit (LSB1-LSB5), and having ultrasonic signal-generating means (6) for generating ultrasonic signals (UT1-UT3; UT4), wherein the ultrasonic signal-generating means (6) are designed to emit the ultrasonic signals to at least one of the loudspeaker units (LSB1-LSB3), which at least one of the loudspeaker units (LSB1-LSB3) is designed to emit the ultrasonic signals, and having ultrasonic signal-receiving means (5) for receiving ultrasonic signals (UR1-UR3; UR4), and having ultrasonic signal-processing means (7) for processing ultrasonic signals received by the ultrasonic signal-receiving means (5), wherein the ultrasonic signal-processing means (7) are designed automatically to detect the presence of at least one person (1) from changes in the received ultrasonic signals (UR1-UR3; UR4) and to emit a detection signal (DS).

2. An audio/video system as claimed in claim 1, wherein the ultrasonic signal-processing means (7) are designed to detect at predetermined intervals echo patterns (signal 1, signal 2) of the ultrasonic signals (UR1-UR3; UR4) received by the ultrasonic signal-receiving means (5) as single sequences over a pre-defined period of time and furthermore to compare the last detected echo pattern (signal 2) with at least one echo pattern detected earlier (signal 1) in order to detect the presence of at least one person (1) from changes in the echo pattern.

3. An audio/video system as claimed in claim 2, wherein the ultrasonic signal-processing means (7) are designed to subdivide each detected echo pattern (signal 1, signal 2) into a number of time slots (TS1 to TS64) and to compare, time slot by time slot, the signal sequences of the echo patterns or parameters to be determined from the echo patterns, such as an average amplitude thereof, in order to detect the presence of at least one person from changes therein.

4. An audio/video system as claimed in claim 3, wherein, through detection of those echo signal time slots (TS63) in which changes were detected, the ultrasonic signal-processing means (7) are designed to determine the distance covered by the ultrasonic signal from its emission via reflection against an object to its arrival at the ultrasonic signal-receiving means (5).

5. An audio/video system as claimed in claim 1, wherein the ultrasonic signal-processing means (7) are designed to determine frequency shifts from the ultrasonic signals (UR1-UR3; UR4) received by the ultrasonic signal-receiving means (5), in order to detect the presence of at least one moving person from the frequency shifts.

6. An audio/video system as claimed in claim 5, wherein the ultrasonic signal-processing means (7) are designed to subdivide the received ultrasonic signals into a plurality of frequency bands and, upon detection of frequency shifts, to take into account only those frequency bands whose signals exceed a level having a pre-defined value.

7. An audio/video system as claimed in claim 5, wherein the ultrasonic signal-processing means (7) are designed to determine the position and the speed of movement of at least one person from the frequency shifts of the received ultrasonic signals on the basis of the Doppler effect, which frequency shifts are detected by the ultrasonic signal-receiving means (5).

8. An audio/video system as claimed in claim 1, wherein the ultrasonic signal-receiving means (5) are in the form of a microphone, preferably in the form of a capacitor microphone.

9. An audio/video system as claimed in claim 1, wherein each loudspeaker unit (LSB1, LSB3), via which loudspeaker unit (LSB1, LSB3) ultrasonic signals are transmittable, comprises a tweeter loudspeaker (8) having a frequency response extending into the respective ultrasonic range.

10. An audio/video system as claimed in claim 1, wherein the audio/video system is designed to prepare a user profile by recording user actions, such as the operation of control devices on the audio reproduction device, for example the implementation of sound settings or the selection of specific radio stations, etc., preferably with concomitant recording of a time reference, in order to carry out the actions recorded in the user profile automatically when the detection signal (DS) is generated by the ultrasonic signal-processing means (7).

11. An audio/video system as claimed in claim 10, wherein preparation of the user profile comprises the correlation of the recorded user actions with one another in order to obtain an improved user profile from the correlated data.

12. An audio/video system as claimed in claim 1, wherein the detection signals (DS) output by the ultrasonic signal-processing means (7) are designed to activate an alarm device (9).

13. An audio/video system as claimed in claim 12, wherein the detection signals (DS) are designed to be transmitted via a telecommunications network (10) to an alarm station.

14. An audio/video system as claimed in claim 1, wherein the ultrasonic signal-generating means (6) are designed to emit ultrasonic signals via at least two loudspeaker units (LSB1, LSB3), and wherein the ultrasonic signal-processing means (7) are designed to determine the position of at least one person (1) present from the received ultrasonic signals (UR3; UR4) and to emit position information by way of the detection signals (DS), and wherein the audio reproduction device (CU) is designed to adjust a favorable setting of the reproduction parameters of the individual audio channels on the basis of the detection signals (DS).

15. An audio/video system as claimed in claim 14, wherein a favorable setting of the volume (balance) of the individual audio channels is determined from the detection signals (DS).

16. An audio/video system as claimed in claim 14, wherein a favorable setting of the propagation delays (delay) of the individual audio channels is determined from the detection signals (DS).

17. An audio/video system as claimed in claim 14, wherein a favorable setting of the frequency characteristics of the individual audio channels is determined from the detection signals (DS).

18. An audio/video system as claimed in claim 14, wherein a favorable setting of the mechanical position of the individual loudspeaker units is determined from the detection signals (DS).

19. An audio/video system as claimed in claim 1, wherein the ultrasonic signal-processing means (7) are designed automatically to determine the location of at least one person (1) from changes in the received ultrasonic signals (UR1-UR3; UR4), and to output location information in the detection signal (DS).
